(19) United States
(12) Patent Application Publication
(10) Pub. No.: US 2026/0158933 A1
(43) Pub. Date: Jun. 11, 2026

(54) ELECTRIFIED VEHICLE

(71) Applicant: TOYOTA JIDOSHA KABUSHIKI KAISHA, Toyota-shi (JP)

(72) Inventors: Satoshi SASAKI, Nagoya-shi (JP); Toshifumi YAMAKAWA, Okazaki-shi (JP)

(73) Assignee: TOYOTA JIDOSHA KABUSHIKI KAISHA, Toyota-shi (JP)

(21) Appl. No.: 19/181,820

(22) Filed: Apr. 17, 2025

(30) Foreign Application Priority Data
Aug. 19, 2024 (JP) 2024-137891

(51) Int. Cl. B60L 15/00; B60L 1/00; B60L 15/20; H02P 27/00

(52) U.S. Cl. CPC B60L 15/007; B60L 1/00; B60L 15/20; B60L 2210/12; B60L 2210/14; B60L 2240/465; H02P 27/00; H02P 2201/07

(57) ABSTRACT

Electrified vehicle includes a motor connected to the drive wheels, an inverter for driving the motor, a power storage device, a buck-boost converter for exchanging electric power between a low-voltage-side power line to which the power storage device is connected and a high-voltage-side power line to which the inverter is connected, an auxiliary device connected to the high-voltage-side power line, and a control device for controlling the inverter, the buck-boost converter, and the auxiliary device. The control device increases the power consumption of the auxiliary device as compared with the case where the predetermined condition is not satisfied when the predetermined condition is satisfied, in which the current flowing through the element of the buck-boost converter is in the direction of the low-voltage-side power line from the high-voltage-side power line and is larger than the threshold value.

### CROSS-REFERENCE TO RELATED APPLICATION

This application claims priority to Japanese Patent Application No. 2024-137891 filed on Aug. 19, 2024. The disclosure of the above-identified application, including the specification, drawings, and claims, is incorporated by reference herein in its entirety.

### BACKGROUND

### 1. Technical Field

The present disclosure relates to an electrified vehicle.

### 2. Description of Related Art

Hitherto, there has been proposed an electrified vehicle including a motor connected to drive wheels, an inverter that drives the motor, a power storage device, and a heating device (see, for example, Japanese Unexamined Patent Application Publication No. 2012-183958 (JP 2012-183958 A)). The heating device includes a drive system cooling circuit and a hot water circuit. The drive system cooling circuit cools the motor and the inverter. In this electrified vehicle, the hot water circuit collects heat generated from a heater in a circulation path through which hot water flows, and heats air by the collected heat during heating, thereby supplying hot air into a vehicle cabin. By using the drive system cooling circuit as the hot water circuit and using the motor and the inverter as the heater, the heat generated from the motor and the inverter is collected in the circulation path of the drive system cooling circuit during traveling.

### SUMMARY

There is an electrified vehicle including a buck-boost converter in addition to the motor connected to the drive wheels, the inverter that drives the motor, and the power storage device. The buck-boost converter exchanges electric power along with voltage conversion between a low-voltage-side power line to which the power storage device is connected and a high-voltage-side power line to which the inverter is connected. In this electrified vehicle, if a relatively large current continues to flow from the high-voltage-side power line to the low-voltage-side power line via the buck-boost converter when the drive wheels are gripped after slipping, the elements of the buck-boost converter may overheat.

An electrified vehicle of the present disclosure can suppress overheating of the elements of the buck-boost converter.

The electrified vehicle of the present disclosure adopts the following measures.

The electrified vehicle of the present disclosure is an electrified vehicle including:
a motor connected to a drive wheel;
an inverter configured to drive the motor;
a power storage device;
a buck-boost converter configured to exchange electric power along with voltage conversion between a low-voltage-side power line to which the power storage device is connected and a high-voltage-side power line to which the inverter is connected;
an auxiliary device connected to the high-voltage-side power line; and
a control device configured to control the inverter, the buck-boost converter, and the auxiliary device.

The control device is configured to, when a predetermined condition is satisfied, increase a power consumption of the auxiliary device in comparison with a case where the predetermined condition is not satisfied. The predetermined condition is a condition that a current flowing through an element of the buck-boost converter is in a direction from the high-voltage-side power line to the low-voltage-side power line and is larger than a threshold value.

In the electrified vehicle of the present disclosure, when the predetermined condition that the current flowing through the element of the buck-boost converter is in the direction from the high-voltage-side power line to the low-voltage-side power line and is larger than the threshold value is satisfied, the power consumption of the auxiliary device is increased in comparison with the case where the predetermined condition is not satisfied. By this process, it is possible to suppress a continuous flow of a relatively large current from the high-voltage-side power line to the low-voltage-side power line via the buck-boost converter. As a result, it is possible to suppress a continuous flow of a relatively large current to the element of the buck-boost converter and to suppress overheating of the element of the buck-boost converter. The buck-boost converter may include an upper arm, a lower arm, and a reactor, and the current flowing through the element of the buck-boost converter may be detected by a current sensor that detects a current flowing through the reactor.

In the electrified vehicle of the present disclosure, the control device may be configured to, when the predetermined condition is satisfied along with gripping of the drive wheel after slipping, increase the power consumption of the auxiliary device in comparison with the case where the predetermined condition is not satisfied. Further, the control device may be configured to, when the predetermined condition is satisfied along with regeneration of the motor, increase the power consumption of the auxiliary device in comparison with the case where the predetermined condition is not satisfied. With this configuration, it is possible to suppress overheating of the element of the buck-boost converter when the predetermined condition is satisfied along with the gripping of the drive wheel after the slipping or when the predetermined condition is satisfied along with the regeneration of the motor.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a battery electric vehicle according to an embodiment of the present disclosure;

FIG. 2 is a flow chart illustrating an exemplary process routine executed by an electronic control unit; and

FIG. 3 is a schematic configuration diagram of a hybrid electric vehicle according to a modification.

### DETAILED DESCRIPTION OF EMBODIMENTS

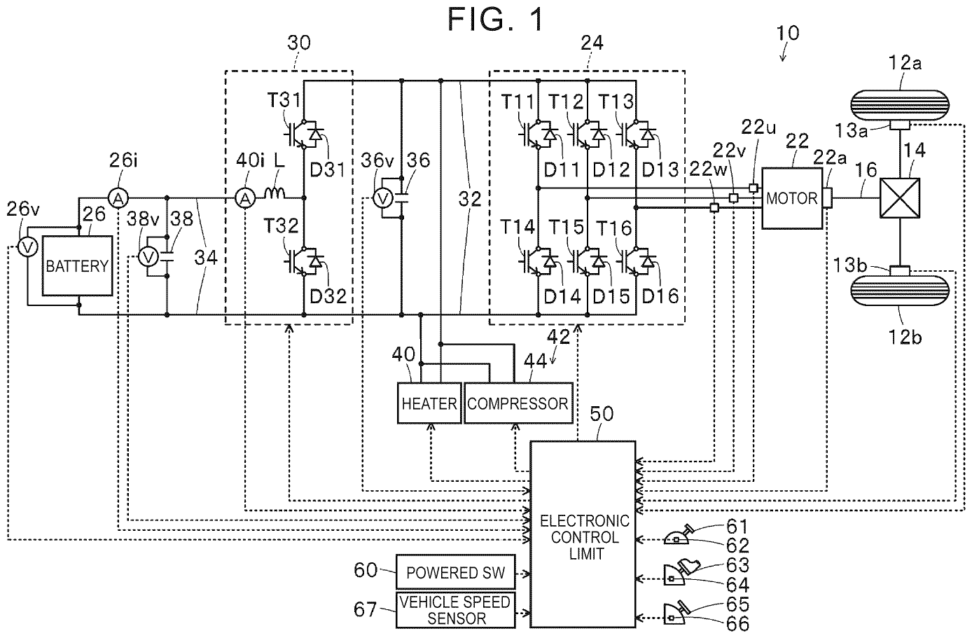

Embodiments for carrying out the present disclosure will be described with reference to the drawings. FIG. 1 is a schematic configuration diagram of a battery electric vehicle 10 according to an embodiment of the present disclosure. As illustrated, battery electric vehicle 10 of the embodiment includes a motor 22, an inverter 24, a battery 26 serving as a power storage device, and a buck-boost converter 30. Battery electric vehicle 10 further includes heaters 40, refrigeration cycles 42, and an electronic control unit 50 as a control device.

The motor 22 is configured as a three-phase AC motor, and includes a rotor in which permanent magnets are embedded in a rotor core, and a stator in which three-phase (U-phase, V-phase, and W-phase) coils are wound around the stator core. The rotor of the motor 22 is connected to a drive shaft 16 connected to the drive wheel 12a, 12b via a differential gear 14.

The inverter 24 is connected to the buck-boost converter 30 via the high-voltage-side power line 32. Inverter 24 includes transistors T11 to T16 as six switching elements, and six diodes D11 to D16 connected in parallel to each of the six transistors T11 to T16. Transistor T11 to T16 are arranged in pairs of two so as to be source side and sink side with respect to the positive line and negative line of the high-voltage-side power line 32, respectively. Each of the connecting points of the transistors which are the pair of the transistors T11 to T16 is connected to each of the three-phase (U-phase, V-phase, and W-phase) coils of the motor 22. Thus, when the inverters 24 are energized, the electronic control unit 50 adjusts the rate of on-time of T16 from the paired transistor T11. As a result, a rotating magnetic field is formed in the three-phase coil of the motor 22, and the motor 22 (rotor) is rotationally driven. A smoothing capacitor 36 is connected to the high-voltage-side power line 32.

The battery 26 is configured as, for example, a lithium-ion secondary battery or a nickel-hydrogen secondary battery, and is connected to the buck-boost converter 30 via the low-voltage-side power line 34. A smoothing capacitor 38 is connected to the low-voltage-side power line 34.

The buck-boost converter 30 is connected to the high-voltage-side power line 32 and the low-voltage-side power line 34. The buck-boost converter 30 includes a transistor T31, T32 (an upper arm and a lower arm) as two switching elements, two diode D31, D32 connected in parallel to each of the two transistors T31, T32, and a reactor L. The transistor T31 is connected to the positive line of the high-voltage-side power line 32. The transistor T32 is connected to the transistor T31 and a common negative line of the high-voltage-side power line 32 and the low-voltage-side power line 34. The reactor L is connected to the connecting points of the two transistors T31, T32 and the positive line of the low-voltage-side power line 34. The electronic control unit 50 adjusts the rate of on-time of the transistor T31, T32. Accordingly, the buck-boost converter 30 boosts the power of the low-voltage-side power line 34 and supplies the boosted power to the high-voltage-side power line 32, or lowers the power of the high-voltage-side power line 32 and supplies the boosted power to the low-voltage-side power line 34.

The heater 40 is connected to the high-voltage-side power line 32. The heater 40 is used as a heat source for heating the vehicle cabin or raising the temperature of the coolant flowing through the circulation flow path including the battery 26. The refrigeration cycle 42 is used as a cooling heat source for cooling the vehicle cabin or cooling the coolant described above, and as a warm heat source for heating the vehicle cabin. The refrigeration cycle 42 includes a compressor 44, a condenser, an expander (expansion valve), and an evaporator. The compressor 44 is connected to the high-voltage-side power line 32 and compresses the refrigerant from the evaporator into a high-temperature and high-pressure gaseous refrigerant. The condenser converts the refrigerant from the compressor 44 into a liquid refrigerant having a normal temperature and a high pressure by heat exchange with air. The expansion valve decompresses the refrigerant from the condenser into a low-temperature, low-pressure gas-liquid mixture refrigerant. The evaporator converts the refrigerant from the expansion valve into a low-temperature and low-pressure gas refrigerant by heat exchange with air. When heating the vehicle cabin, the air heated by heat exchange with the heater 40 and/or the condenser is blown into the vehicle cabin by a blower. When cooling the vehicle cabin, air cooled by heat exchange with an evaporator is blown into the vehicle cabin by a blower. The coolant in the circulation flow path is heated by the heater 40 and/or the refrigeration cycle 42 or cooled by the refrigeration cycle 42.

The electronic control unit 50 includes a microcomputer having a CPU, ROM, RAM, a flash memory, an input/output port, and a communication port, various driving circuitry, and various logic IC. The electronic control unit 50 receives signals from various sensors. For example, the electronic control unit 50 receives the rotation speed Nwa, Nwb of the drive wheel 12a, 12b from the rotation speed sensor 13a, 13b attached to the drive wheel 12a, 12b. The electronic control unit 50 also receives the rotational position θm of the rotor of the motor 22 from the rotational position sensor 22a that detects the rotational position of the rotor of the motor 22. The electronic control unit 50 also receives phase current Iu, Iv, Iw for each phase of the motor 22 from a current sensor 22u, 32v, 32w attached to each phase of the motor 22. The electronic control unit 50 also receives a voltage Vb of the battery 26 from a voltage sensor 26v mounted between terminals of the battery 26 and a current Ib of the battery 26 from a current sensor 26i mounted at an output terminal of the battery 26. The electronic control unit 50 also receives the current IL of the reactor L, the voltage VH of the capacitor 36 (high-voltage-side power line 32), and the voltage VL of the capacitor 38 (low-voltage-side power line 34). The current IL of the reactor L is from a current sensor 30i mounted in series with the reactor L of the buck-boost converter 30. The voltage VH of the capacitor 36 is from a voltage sensor 36v mounted between the terminals of the capacitor 36. The voltage VL of the capacitor 38 is from a voltage sensor 38v mounted between the terminals of the capacitor 38. The electronic control unit 50 also receives a switch signal from the power switch 60, a shift position SP from the shift sensor 62, and an accelerator operation amount Acc from the accelerator pedal position sensor 64. The electronic control unit 50 also receives the brake pedal position BP from the brake pedal position sensor 66 and the vehicle speed V from the vehicle speed sensor 67. The shift sensor 62 detects an operation position of the shift lever 61. The accelerator pedal position sensor 64 detects the amount of depression of the accelerator pedal 63. The brake pedal position sensor 66 detects a depression amount of the brake pedal 65.

The electronic control unit 50 outputs various control signals. For example, the electronic control unit 50 outputs a control signal from the transistor T11 to T16 of the inverter 24 and a control signal to the transistor T31, T32 of the buck-boost converter 30. The electronic control unit 50 also outputs a control signal to the heater 40 and a control signal to the compressor 44 of the refrigeration cycle 42. The electronic control unit 50 calculates the electric angle θe and the rotation speed Nm of the motor 22 based on the rotational position θm of the rotor of the motor 22 from the rotational position sensor 22a. The electronic control unit 50 calculates the power storage ratio SOC of the battery 26 based on the integrated value of the current Ib of the battery 26 from the current sensor 26i.

In battery electric vehicle 10 of the embodiment configured as described above, the electronic control unit 50 sets the required torque Td* (required for the drive shaft 16) required for traveling based on the accelerator operation amount Acc and the vehicle speed V. The electronic control unit 50 sets the set required torque Td* to the torque command Tm* of the motor 22 so as to be outputted to the drive shaft 16. Further, the electronic control unit 50 performs switching control of T16 from the transistor T11 of the inverter 24 so that the motor 22 is driven by the torque command Tm*. Further, the electronic control unit 50 sets the motor 22 to the target voltage VH* of the high-voltage-side power line 32 based on the torque command Tm* and the rotation speed Nm. The electronic control unit 50 calculates the target current IL* of the reactor L by voltage feedback control so that the difference between the voltage VH of the high-voltage-side power line 32 and the target voltage VH* is

cancelled out. Subsequently, the electronic control unit 50 calculates the duty command D* by the current feedback control so that the difference between the current IL of the reactor L and the target current IL* is cancelled out. The electronic control unit 50 performs switching control of the transistor T31, T32 of the buck-boost converter 30 using the calculated duty command D*.

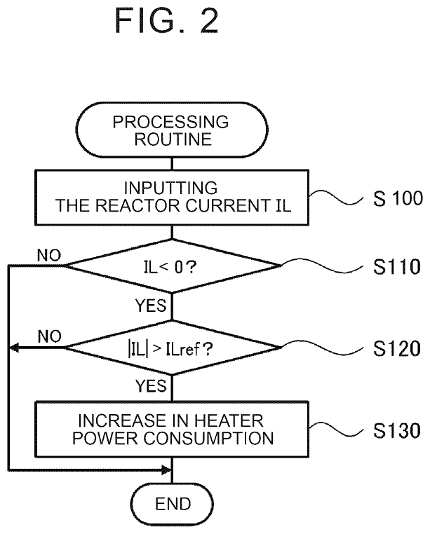

Next, the operation of battery electric vehicle 10 of the embodiment will be described. In particular, the operation when the drive wheel 12a, 12b is gripped after slipping will be described. FIG. 2 is a flowchart illustrating an example of a processing routine executed by the electronic control unit 50. This routine is repeatedly executed for a predetermined period of time after detecting that the drive wheel 12a, 12b has slipped and then gripped. The slipping of the drive wheel 12a, 12b and the subsequent gripping can be detected by using the rotation speed change rates ΔNwa and ΔNwb. The rotation speed change rates ΔNwa and ΔNwb are, for example, changes in the rotation speed Nwa, Nwb of the drive wheel 12a, 12b from the rotation speed sensor 13a, 13b per unit time.

When the process of FIG. 2 is executed, the electronic control unit 50 receives the current IL of the reactor L from the current sensor 30i (the direction of the high-voltage-side power line 32 is positive from the low-voltage-side power line 34) (S100). The electronic control unit 50 determines whether the current IL of the inputted reactor L is negative and whether a predetermined condition in which the absolute value is larger than the threshold value ILref is satisfied (S110, S120). Here, the threshold value ILref is a threshold value used for determining whether or not a relatively large current flows from the high-voltage-side power line 32 to the low-voltage-side power line 34 via the buck-boost converter 30. When the drive wheel 12a, 12b slips during traveling of the vehicle, that is, the rotation speed Nwa, Nwb of the drive wheel 12a, 12b increases rapidly, the rotation speed Nm of the motor 22 also increases rapidly, and thus Pm of power consumed by the motor 22 increases rapidly. Then, when the drive wheel 12a, 12b is subsequently gripped, that is, the rotation speed Nwa, Nwb of the drive wheel 12a, 12b is rapidly decreased, the rotation speed Nm of the motor 22 is rapidly decreased, and therefore the power consumed by the motor 22 is rapidly decreased. At this time, in the above-described control of the buck-boost converter 30, the target voltage VH* of the high-voltage-side power line 32 may be sufficiently lower than the voltage VH. Further, there is a possibility that the target current IL* of the reactor L is negative and its absolute value is relatively large, the current IL of the reactor L is negative, and its absolute value is relatively large (a relatively large current flows from the high-voltage-side power line 32 to the low-voltage-side power line 34 via the buck-boost converter 30). S110, S120 process is a process for detecting such an event.

In S110, S120, when the current IL of the reactor L is 0 or positive, or when the current IL of the reactor L is negative and the absolute value thereof is less than or equal to the threshold value ILref, that is, when the predetermined condition is not satisfied, the routine ends.

In S110, S120, when the current IL of the reactor L is negative and the absolute value thereof is larger than the threshold value ILref, that is, when the predetermined condition is satisfied, the power consumed by the heaters 40 is increased compared to when the predetermined condition is not satisfied (S130). Exit this routine. In S130 process, the power consumption of the heater 40 is increased or the power consumption of the heater 40 during driving is increased by starting the driving of the heater 40 from stopping. With such a process, when the predetermined condition is satisfied, the power consumption of the heater 40 can be made larger than when the predetermined condition is satisfied. Therefore, it is possible to suppress a continuous flow of a relatively large current from the high-voltage-side power line 32 to the low-voltage-side power line 34 through the buck-boost converter 30. As a consequence, it is possible to prevent a relatively large current from continuing to flow through the element (for example, the transistor T31) of the buck-boost converter 30, and to suppress overheating of the element of the buck-boost converter 30.

In battery electric vehicle 10 of the above-described embodiment, when a predetermined condition is satisfied in which the current IL of the reactor L is negative and the absolute value thereof is larger than the threshold value ILref in accordance with the gripping after slipping of the drive wheel 12a, 12b, the power consumed by the heaters 40 is increased in comparison with the case where the predetermined condition is not satisfied. As a result, it is possible to prevent a relatively large current from continuing to flow through the element (for example, the transistor T31) of the buck-boost converter 30, and to suppress overheating of the element of the buck-boost converter 30.

In the above-described embodiment, when the predetermined condition is satisfied with the grip after the slip of the drive wheel 12a, 12b, the power consumed by the heaters 40 is increased as compared with the case where the predetermined condition is not satisfied, but the present disclosure is not limited thereto. For example, when the predetermined condition is satisfied with the regeneration of the motor 22, such as when the driver depresses the brake pedal 65 to a large extent, the power consumption of the heater 40 may be increased as compared with when the predetermined condition is not satisfied. In addition, when the predetermined condition is satisfied, the power consumed by the heaters 40 may be increased as compared with when the predetermined condition is not satisfied, except when the drive wheel 12a, 12b is gripped after slipping or when the motor 22 is regenerated.

In the above-described embodiment, when the predetermined condition is satisfied, the power consumption of the heater 40 is increased compared to when the predetermined condition is not satisfied, but the present disclosure is not limited thereto. For example, in addition to or instead of increasing the power consumption of the heater 40, the power consumption of the compressor 44 of the refrigeration cycle 42 may be increased.

In the above-described embodiment, battery electric vehicle 10 is such that both the heater 40 and the compressor 44 of the refrigeration cycle 42 are connected to the high-voltage-side power line 32, but is not limited thereto. For example, one of the heater 40 and the compressor 44 may be connected to the high-voltage-side power line 32 and the other may be connected to the low-voltage-side power line 34. In this case, when the predetermined condition is satisfied, the power consumption of the heater 40 and the compressor 44 connected to the high-voltage-side power line 32 may be increased as compared with when the predetermined condition is not satisfied.

In the above-described embodiment, battery electric vehicle 10 includes the battery 26 as the power storage device, but is not limited thereto. For example, the power storage device may include a capacitor or the like in addition to or in place of the battery.

In the above-described embodiment, battery electric vehicle 10 includes the motor 22 connected to the drive shaft 16 connected to the drive wheel 12a, 12b via the differential gear 14, but is not limited thereto. For example, two in-wheel motors may be provided, each attached to (connected to) a drive wheel 12a, 12b.

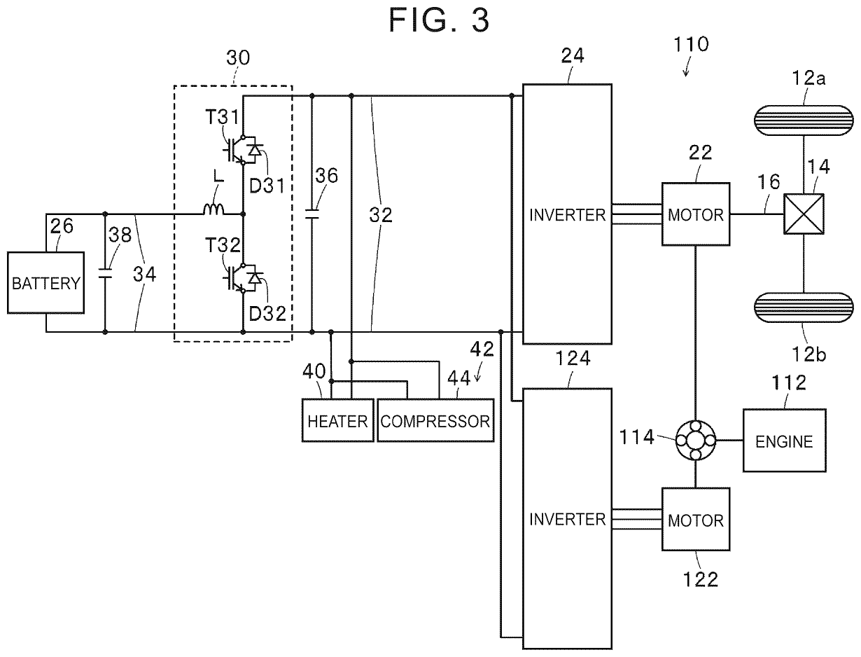

In the above-described embodiment, as illustrated in FIG. 1, a battery electric vehicle 10 configuration is employed in which the motor 22, the inverter 24, the battery 26, the buck-boost converter 30, the heater 40, and the compressor 44 of the refrigeration cycle 42 are provided. However, it is not limited thereto. For example, hybrid electric vehicle may be configured to further include an engine in addition to a hardware configuration similar to that of battery electric vehicle 10. In addition, fuel cell electric vehicle may further include a fuel-cell in addition to a hardware configuration similar to that of battery electric vehicle 10. In hybrid electric vehicle configuration, for example, as shown in hybrid electric vehicle 110 of the modification of FIG. 3, in addition to the hardware configuration similar to battery electric vehicle 10, the engine 112, the planetary gear 114, the motor 122, and the inverter 124 may be further provided. In hybrid electric vehicle 110, the motor 22, the engine 112, and the motor 122 are connected to the ring gear, the carrier, and the sun gear of the planetary gear 114, respectively. In hybrid electric vehicle 110, an inverter 124 for driving the motor 122 is further connected to the high-voltage-side power line 32. Further, in hybrid electric vehicle configuration, in addition to the hardware configuration similar to battery electric vehicle 10, a transmission may be provided between the drive shaft 16 and the motor 22, and the motor 22 may be connected to the engine via a clutch.

The correspondence between the main elements of the embodiments and the main elements of the disclosure described in the column of the means for solving the problem will be described. In the embodiment, the motor 22 corresponds to the “motor”, the inverter 24 corresponds to the “inverter”, and the battery 26 corresponds to the “power storage device”. The buck-boost converter 30 corresponds to a “buck-boost converter”, the heater 40 corresponds to an “auxiliary device”, and the electronic control unit 50 corresponds to a “control device”.

The correspondence between the main elements of the embodiment and the main elements of the disclosure described in the section of the means for solving the problem is an example for specifically explaining the embodiment of the disclosure described in the section of the means for solving the problem. Therefore, the elements of the disclosure described in the section of the means for solving the problem are not limited. That is, the interpretation of the disclosure described in the section of the means for solving the problem should be performed based on the description in the section, and the embodiments are only specific examples of the disclosure described in the section of the means for solving the problem.

Hereinafter, while embodiments for carrying out the present disclosure are described by using embodiments, it is needless to say that the present disclosure is not limited to such embodiments, and can be implemented in various forms without departing from the gist of the present disclosure.

The present disclosure is applicable to a manufacturing industry of an electrified vehicle and the like.

What is claimed is:

1. An electrified vehicle comprising:
a motor connected to a drive wheel;
an inverter configured to drive the motor;
a power storage device;
a buck-boost converter configured to exchange electric power along with voltage conversion between a low-voltage-side power line to which the power storage device is connected and a high-voltage-side power line to which the inverter is connected;
an auxiliary device connected to the high-voltage-side power line; and
a control device configured to control the inverter, the buck-boost converter, and the auxiliary device, wherein
the control device is configured to, when a predetermined condition is satisfied, increase a power consumption of the auxiliary device in comparison with a case where the predetermined condition is not satisfied, the predetermined condition being a condition that a current flowing through an element of the buck-boost converter is in a direction from the high-voltage-side power line to the low-voltage-side power line and is larger than a threshold value.

2. The electrified vehicle according to claim 1, wherein the control device is configured to, when the predetermined condition is satisfied along with gripping of the drive wheel after slipping, increase the power consumption of the auxiliary device in comparison with the case where the predetermined condition is not satisfied.

3. The electrified vehicle according to claim 1, wherein the control device is configured to, when the predetermined condition is satisfied along with regeneration of the motor, increase the power consumption of the auxiliary device in comparison with the case where the predetermined condition is not satisfied.
